(19) United States
(12) Patent Application Publication
(10) Pub. No.: US 2001/0030684 A1
(43) Pub. Date: Oct. 18, 2001

(54) Electronic endoscope

(75) Inventors: Masaaki Nakashima, Saitama (JP); Naoki Kikuchi, Tokyo (JP)

Correspondence Address: GREENBLUM & BERNSTEIN, P.L.C., 1941 ROLAND CLARKE PLACE, RESTON, VA, 20191, US

(73) Assignee: ASAHI KOGAKU KOGYO KABUSHIKI KAISHA, Tokyo (JP)

(21) Appl. No.: 09/826,922

(22) Filed: Apr. 6, 2001

(30) Foreign Application Priority Data
Apr. 14, 2000 (JP) 2000-113711 (P)

(51) Int. Cl. H04N 7/18

(52) U.S. Cl. 348/65

(57) ABSTRACT

An electronic endoscope having an image pickup portion which converts an object image formed by an objective lens system to an electrical image signal, includes a solid-state image pickup device having an image sensor, a controller for controlling the horizontal and vertical scan direction of an image portion of the image sensor, and a scan control device which controls the scanning operation of the image sensor. The image sensor and either the scan control device or the controller are integrated on a common chip.

### BACKGROUND OF THE INVENTION

1. Field of the Invention

The present invention relates to an electronic endoscope which is adapted to produce an image of an inner part of a living body for the purpose of diagnosis and medical treatment.

2. Description of the prior Art

In a conventional fiberscope or electronic endoscope, an external operation portion and an image monitor are connected to an image pickup portion which is inserted in a human body via a flexible tube. To ease a patient's pain during viewing or examination, attempts have been made to miniaturize the image pickup portion and to reduce the diameter of the flexible tube. It is possible to miniaturize the image pickup portion by making an image sensor provided in the image pickup portion small, however, it is difficult to reduce the diameter of the flexible tube since there is a large number of signal lines connecting the operation portion and the image monitor, etc., to the image pickup portion.

### SUMMARY OF THE INVENTION

It is an object of the present invention to provide an electronic endoscope in which the diameter of the flexible tube can be reduced.

To achieve the object mentioned above, according to an aspect of the present invention, an electronic endoscope is provided, having an image pickup portion which converts an object image formed by an objective lens system to an electrical image signal, including a solid-state image pickup device having an image sensor, a controller for controlling the horizontal and vertical scan direction of an image portion of the image sensor, and a scan control device which controls the scanning operation of the image sensor. The image sensor and either the scan control device or the controller are integrated on a common chip.

According to another aspect of the present invention, an electronic endoscope is provided, having an image pickup portion which is provided at a distal end of a tubular member of the electronic endoscope. The image pickup portion is provided with a solid-state image pickup device having an image sensor. The image sensor and either a controller, for controlling the horizontal and vertical scan direction of an image portion of the image sensor, or a scan control device, for controlling the scanning operation of the image sensor, are integrated on a common chip.

According to the above described structures, the number of the signal lines to be connected to the image pickup portion can be reduced, and hence the diameter of the tubular portion of the endoscope can be decreased.

In an embodiment, the image pickup portion includes an A/D converter for carrying out A/D conversion of an output signal of the image sensor, an image processing device for processing the A/D-converted output signal, and a D/A converter for carrying out D/A conversion of the processed image signal. At least one of the A/D converter device, the image processing device, and the D/A converter is integrated in the solid-state image pickup portion.

Preferably, the image processing device has an automatic white balance function to carry out a white balance operation.

Preferably, the electronic endoscope further includes a scan direction changing device, wherein the scan direction changing device causes the controller to change the scan direction of the image sensor.

Preferably, the scan direction changing device includes a vertical scan direction changing member to change the scan direction of the image sensor in the vertical direction, and a horizontal scan direction changing member to change the scan direction of the image sensor in the lateral direction.

Preferably, the scan direction changing device is provided with a horizontal/vertical scan switching member to switch the horizontal scan and the vertical scan of the image sensor.

Preferably, the image sensor is a MOS type image sensor having a horizontal scan register and a vertical scan register.

In an embodiment, the scan direction changing device is provided at the other end of the tubular member.

Preferably, the electronic endoscope further includes an image monitor in which an image picked-up by the image pickup portion is indicated.

According to another aspect of the present invention, an electronic endoscope is provided, having an image pickup portion which is provided at a distal end of a tubular member of the electronic endoscope, including a solid-state image pickup device in which an image sensor and a scan control device for controlling the scanning operation of the image sensor are integrated on a common chip, and a scan direction changing device which changes the scan direction of the image sensor.

In an embodiment, the scan direction changing device is provided at the other end of the tubular member.

The present disclosure relates to subject matter contained in Japanese Patent Application No.2000-113711 (filed on Apr. 14, 2000) which is expressly incorporated herein by reference in its entirety.

### BRIEF DESCRIPTION OF THE DRAWINGS

The invention will be discussed below in detail with reference to the accompanying drawings, in which:

FIG. 1 is a schematic view of an electronic endoscope according to the present invention; and

FIG. 2 is a block diagram of main parts of an electronic endoscope shown in FIG. 1.

### DESCRIPTION OF THE PREFERRED EMBODIMENT

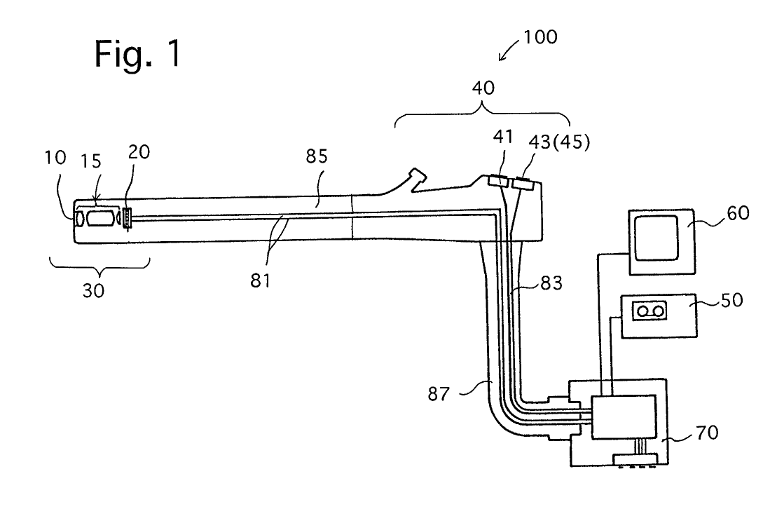

In FIG. 1 which shows an embodiment of an electronic endoscope of the present invention, the electronic endoscope 100 includes an image pickup portion 30 and an operation portion 40 which is integrally connected thereto by a first soft tubular portion (tubular member) 85, a recording device 50, an image monitor 60, and a processor 70 which generally controls each component. The electronic endoscope 100 is provided with a bending mechanism (not shown) to bend the image pickup portion 30 in an optional direction, and the image pickup portion 30 is provided with a lighting device for illuminating the inside of a human cavity and/or a forceps receptacle in accordance with need. When the electronic endoscope 100 is used for diagnosis or medical treatment, etc., the image pickup portion 30 is inserted in a patient's body cavity and is oriented in an optional direction by the operating portion 40 to pickup an image of the inner part of the human cavity; the image information thus obtained is recorded in the recording device 50 through the processor 70 and is displayed in the monitor 60, so that diagnosis or necessary treatments can be carried out. The image information recorded in the recording device 50 can be read out through a recording medium and can be subject to further processes, if necessary.

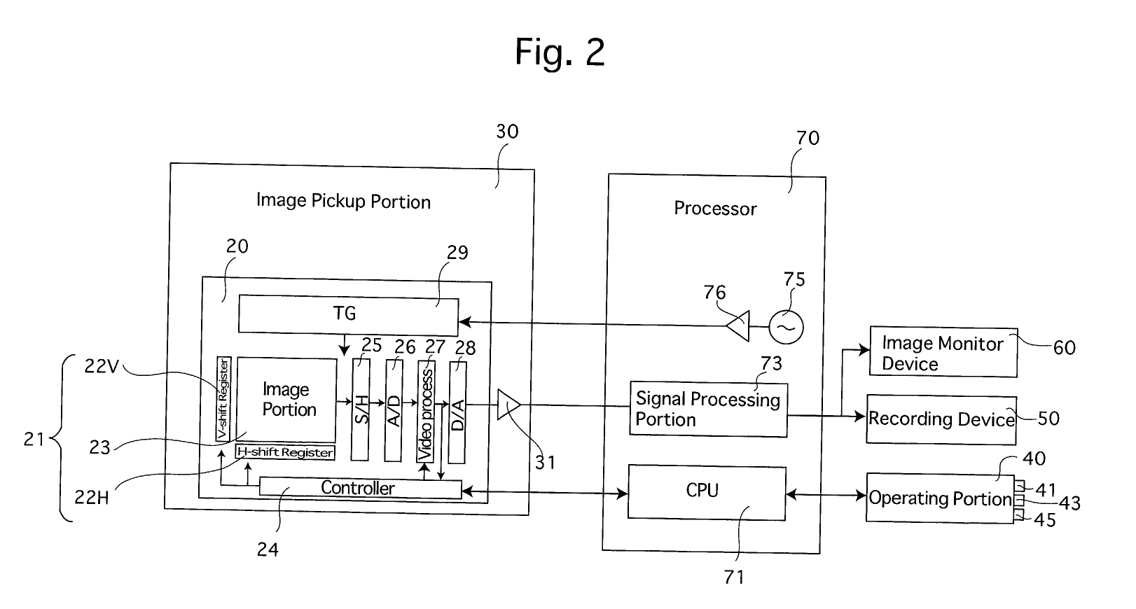

The image pickup portion 30 includes a transparent cover 10 constructed from a transparent material, an objective optical system 15, and a solid-state image pickup device 20, in this order from the front of the electronic endoscope 100 (in the left direction in FIG. 1). The solid-state image pickup device 20 includes an image sensor 21 and peripheral circuits thereof, integrated on the same (common) chip (FIG. 2), as will be discussed in detail hereinafter. The solid-state image pickup device 20 is connected to the processor 70 through signal lines 81 in the first tubular portion 85. The operating portion 40 includes a horizontal/vertical scan switching member 41 to switch the horizontal scan and the vertical scan of the image sensor 21, a horizontal scan direction changing member 43 to change the horizontal scan direction of the image sensor 21, and a vertical scan direction changing member 45 to change the vertical scan direction of the image sensor 21. The operating portion 40 is connected to the processor 70 through the signal lines 83 in the second tubular portion 87. In the illustrated embodiment, each time the horizontal/vertical scan switching member 41, the horizontal scan direction changing member 43, or the vertical scan direction changing member 45 is operated, the corresponding scan direction is changed.

The structure of the solid-state image pickup device 20 and the control system of the processor 70 will be discussed below with reference to a block diagram shown in FIG. 2. The solid-state image pickup device 20 includes the image sensor 21, a controller 24, a sample-and-hold circuit (referred to as an S/H circuit) 25, an A/D converter 26, a video processor circuit (image processing device) 27, a D/A converter 28, and a timing generator (scan control device) 29. These elements are all integrated on the same chip.

The timing generator 29 functions as a scan control device for controlling the scan timing of the image sensor 21. The timing generator 29 generates a synchronization signal in response to a clock signal of the oscillator 75 input thereto, so that the scanning of the image sensor 21 is controlled in accordance with the synchronization signal. The clock signal generated by the oscillator 75 is amplified by an amplifier 76 and is supplied to the timing generator 29 through the processor 70.

The image sensor 21 is an MOS (metal oxide semiconductor) type image sensor which successively outputs the accumulated charges (accumulated signal) of each cell. The image sensor 21 is provided with an image portion 23 in which light received thereby through the objective optical system 15 is converted to an electric signal for each cell and the electric signals are accumulated, and a horizontal direction scanning shift register 22H and a vertical direction scanning shift register 22V for the image portion 23. The horizontal direction scanning shift register 22H and the vertical direction scanning shift register 22V sequentially scans each cell of the image portion 23 in response to the synchronization signal generated from the timing generator 29 to sequentially read the accumulated charges (accumulated signal).

The accumulated signal read from the image sensor 21 is converted to voltage for each cell by the S/H circuit 25, is subject to A/D conversion by the A/D converter 26, and is converted to an image signal by the video processor circuit 27. The video processor circuit 27 has an image processing function to process the input signal and an automatic white balance function. The controller 24 outputs a gain control signal to control the gain (amplification rate) of the R, G, B outputs, to the video processor circuit 27, in accordance with the intensities of the R, G, B signals of the image signal converted by the video processor circuit 27.

The image signal supplied from the video processor circuit 27 to the D/A converter 28 is subject to D/A conversion, is amplified by the amplifier 31, and is supplied to the processor 70.

In addition to the oscillator 75 and the amplifier 76, the processor 70 includes a CPU (scan direction changing device) 71, and a signal processing portion 73 which processes the image signal output from the image pickup portion 30 and which supplies the image signal to the recording device 50 and to the image monitor 60.

The operating portion 40 and the controller 24 are connected to the CPU 71. The CPU 71 causes the controller 24 to invert the scan direction of the horizontal direction scanning shift register 22H when the horizontal scan direction changing member 43 is operated, so that the image displayed in the monitor 60 is inverted in the lateral direction. Likewise, the CPU 71 causes the controller 24 to invert the scan direction of the vertical direction scanning shift register 22V when the vertical scan direction changing member 45 is operated, so that the image displayed in the monitor 60 is inverted in the vertical direction.

The CPU 71 causes the controller 24 to reverse the function of the horizontal direction scanning shift register 22H and the vertical direction scanning shift register 22V when the horizontal/vertical scan switching member 41 is operated. Consequently, since the scan direction of any one of the horizontal direction scanning shift register 22H and the vertical direction scanning shift register 22V is inverted, and the image displayed in the monitor 60 is turned by 90 degrees.

Note that in an alternative arrangement in which the scan direction of the horizontal direction scanning shift register 22H or the vertical direction scanning shift register 22V is inverted after the function of the horizontal direction scanning shift register 22H and the vertical direction scanning shift register 22V is reversed, the image indicated in the monitor 60 is turned by 180 degrees each time the horizontal/vertical scan switching member 41 is operated.

Therefore, if the horizontal/vertical scan switching member 41, the horizontal scan direction changing member 43 and the vertical scan direction changing member 45 are operated in combination, the image indicated in the monitor 60 can be inverted in the vertical direction or in the lateral direction or in both the vertical and lateral directions, or can be turned by 90 degree steps.

For instance, if it is assumed that the image is scanned in the horizontal direction from left toward right, in an initial position, if an operator (user) wants to invert the image displayed in the monitor 60 in the lateral direction, the operator operates the horizontal scan direction changing member 43. Likewise, if an operator wants to invert the image displayed in the monitor 60 in the vertical direction or in both the horizontal and vertical directions, he or she operates the vertical scan direction changing member 45 or both the horizontal scan direction changing member 43 and the vertical scan direction changing member 45. Moreover, if an operator wants to turn the image displayed in the monitor 60 by 90 degrees from the initial position, the operator operates the horizontal/vertical scan switching member 41 once. To turn the image by 180 degrees and 270 degrees, the horizontal/vertical scan switching member 41 is operated twice and three times, respectively. If the horizontal/vertical scan switching member 41 is operated four times, the image is turned by 360 degrees so as to return the image to the initial position.

In general, the electronic endoscope 100 constructed as above is used as follows.

When the image pickup portion 30 is inserted in a patient's body, the image pickup portion 30, the image of the portion of the patient (object to be examined) located in front of the transparent cover 10 is picked up by the image pickup device 30. The picked-up (produced) image is subject to an image processing operation and is supplied to the processor 70 as an image signal. The image signal is thereafter processed in the signal processing portion 73, is recorded in the recording device 50, and is indicated in the monitor 60. The operator directs the image pickup portion 30 in a desired direction and observes and takes pictures of the patient's cavity, while viewing the image indicated in the monitor 60. The direction of the image pickup portion 30 is optionally changed in the vertical and lateral directions within the patient's body cavity, and the change in the direction of the image pickup portion 30 in the vertical direction occurs also when the first tubular portion 85 is bent at the intermediate portion thereof. If a change in the direction of the image pickup portion 30 takes place, the image indicated in the monitor 60 may be difficult to view. To solve this problem, the horizontal/vertical scan switching member 41, the horizontal scan direction changing member 43 or the vertical scan direction changing member 45, of the operating portion 40 is appropriately operated, so that the image indicated in the monitor 60 can be turned by 90 degrees or inverted in the lateral direction or vertical direction. Upon completion of the viewing operation, the image information recorded by the recording device 50 can be read from the image recording medium and can be subject to further processes in accordance with need.

Although, in the illustrated embodiment, the solid-state image pickup device 20 includes the image sensor 21, the controller 24, the sample-and-hold circuit 25, the A/D converter 26, the video processor circuit 27, the D/A converter 28 and the timing generator 29, all integrated on the same chip, it is possible to integrate only some of the elements or circuits or to integrate other circuits or electric elements. Namely, if the number of the signal lines provided in the first tubular portion 85 is reduced by integrating the peripheral circuits of the image sensor 21 within the solid-state image pickup device 20, the diameter of the first tubular portion 85 can be reduced.

In the illustrated embodiment, the horizontal scan direction changing member 43 and the vertical scan direction changing member 45 to change the direction of the scan direction of the horizontal direction scanning shift register 22H and the vertical direction scanning shift register 22V, respectively are provided in the operating portion 40, so that the scan direction of the image sensor 21 can be changed externally. Consequently, it is not necessary to provide a rotation mechanism for rotating the image sensor 21 or an inverting circuit for inverting the picked-up image in the image pickup portion 30, thus resulting in miniaturization of the image pickup portion 30.

It is possible to provide an adjusting member which adjusts the lightness and contrast, etc., on the operating portion 40. With this arrangement, since a user can adjust the image state by operating the adjusting member, while viewing the image indicated in the monitor 60, the operation efficiency can be enhanced. Although the image pickup portion 30 and the operating portion 40 are integrally connected by the first tubular member 85 in the illustrated embodiment, it is possible to separate the image pickup portion 30 from the operating portion 40. For example, it is possible to provide the image pickup portion 30 at the distal end of the first tubular member 85 as in the illustrated embodiment and to provide the operating portion 40 on the processor 70.

As can be understood from the above discussion, according to the present invention, since a solid-state image pickup device is employed in which the image sensor and the scan control device for controlling the scanning of the image sensor are integrated on the same chip, the number of the signal lines to be connected to the image pickup portion can be reduced, and hence the diameter of the tubular portion of the endoscope can be decreased. Moreover, since the operating portion is provided with the scanning direction changing device for changing the scanning direction of the image sensor, the circuit of the image pickup portion can be made small, thus leading to miniaturization of the image pickup portion.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. An electronic endoscope having an image pickup portion which converts an object image formed by an objective lens system to an electrical image signal, comprising:
a solid-state image pickup device having an image sensor;
a controller for controlling the horizontal and vertical scan direction of an image portion of said image sensor; and
a scan control device which controls the scanning operation of said image sensor; wherein
said image sensor and one of said scan control device and said controller are integrated on a common chip.

2. An electronic endoscope having an image pickup portion which is provided at a distal end of a tubular member of said electronic endoscope; and
wherein the image pickup portion is provided with a solid-state image pickup device having an image sensor; and
wherein said image sensor and one of a controller, for controlling the horizontal and vertical scan direction of an image portion of said image sensor, and a scan control device, for controlling the scanning operation of the image sensor, are integrated on a common chip.

3. The electronic endoscope according to claim 2, wherein said image pickup portion comprises an A/D converter for carrying out A/D conversion of an output signal of the image sensor, an image processing device for processing the A/D-converted output signal, and a D/A converter for carrying out D/A conversion of the processed image signal; wherein at least one of the A/D converter device, the image processing device, and the D/A converter is integrated in the solid-state image pickup portion.

4. The electronic endoscope according to claim 3, wherein said image processing device has an automatic white balance function to carry out a white balance operation.

5. The electronic endoscope according to claim 2, further comprising a scan direction changing device, wherein said scan direction changing device causes the controller to change the scan direction of the image sensor.

6. The electronic endoscope according to claim 5, wherein said scan direction changing device comprises a vertical scan direction changing member to change the scan direction of the image sensor in the vertical direction, and a horizontal scan direction changing member to change the scan direction of the image sensor in the lateral direction.

7. The electronic endoscope according to claim 5, wherein said scan direction changing device is provided with a horizontal/vertical scan switching member to switch the horizontal scan and the vertical scan of the image sensor.

8. The electronic endoscope according to claim 2, wherein said image sensor is a MOS type image sensor having a horizontal scan register and a vertical scan register.

9. The electronic endoscope according to claim 5, wherein said scan direction changing device is provided at the other end of the tubular member.

10. The electronic endoscope according to claim 5, further comprising an image monitor in which an image picked-up by the image pickup portion is indicated.

11. An electronic endoscope having an image pickup portion which is provided at a distal end of a tubular member of said electronic endoscope, comprising:
a solid-state image pickup device in which an image sensor and a scan control device for controlling the scanning operation of the image sensor are integrated on a common chip; and
a scan direction changing device which changes the scan direction of the image sensor.

12. The electronic endoscope according to claim 11, wherein said scan direction changing device is provided at the other end of the tubular member.
